(19) United States
(12) Patent Application Publication
(10) Pub. No.: US 2018/0304489 A1
(43) Pub. Date: Oct. 25, 2018

(54) LUBRICATION INSERT FOR CHAIN SAW GUIDE BAR

(71) Applicant: Blount, Inc., Portland, OR (US)

(72) Inventors: Don Cornette, Portland, OR (US); Eric M. Burmester, Happy Valley, OR (US); James Matthew Cunnington, Tualatin, OR (US)

(21) Appl. No.: 15/957,628

(22) Filed: Apr. 19, 2018

Related U.S. Application Data
(60) Provisional application No. 62/487,379, filed on Apr. 19, 2017.

(51) Int. Cl. B27B 17/12

(52) U.S. Cl. CPC B27B 17/12; B27B 17/02

(57) ABSTRACT

Embodiments provide for a lubricant delivery system that includes a saw chain guide bar, such as a harvester bar, and an integrated lubrication channel insert that is insertable into the saw chain guide bar. Oil, grease, or other lubricant can be passed to the chain to the groove bottom to lubricate the chain during use though the lubrication channel insert, as disclosed herein. The lubricant enters the groove via the lubrication channel insert opening into the guide groove in the region of the groove bottom. The lubrication channel insert is coupled to the guide bar and is fed from a transverse lubrication channel lying below the groove bottom. Also provided is a lubrication channel insert.

### CROSS-REFERENCE TO RELATED APPLICATION

This application claims the priority benefit of the earlier filing date of U.S. Provisional Application No. 62/487,379, filed Apr. 19, 2017, which is hereby incorporated herein by reference in its entirety.

### TECHNICAL FIELD

Embodiments herein relate to the field of chainsaws, and, more specifically, to devices and systems for supplying lubricant to the chain of a chain saw.

### BACKGROUND

Chain saws typically include a saw chain loop disposed to articulate around a guide bar, the chain comprising various coupled links including cutter links, drive links, and tie straps. The cutter links and tie straps are typically in sliding engagement on bar rails of the guide bar.

Typically, a guide bar is clamped to a motor-driven saw, such as a harvester machine or hand held chainsaw. To lubricate the chain, lubricant is introduced into a guide groove that is formed in the periphery of the guide bar for the saw chain. The lubricant enters via a feed channel opening into the guide groove in the region of the groove bottom. The feed channel is fed from a transverse channel lying below the groove bottom that is coupled to a lubricant source.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 illustrates a perspective view of a lubrication channel insert, in accordance with various embodiments;

FIG. 2 illustrates a top view of a lubrication channel insert, in accordance with various embodiments;

FIG. 3 illustrates a bottom view of a lubrication channel insert, in accordance with various embodiments;

FIGS. 4-8 illustrate side views of a chainsaw bar including a lubrication channel insert, in accordance with various embodiments; and

FIGS. 9 and 10 illustrate an insert cutout or hole in the guide bar, in accordance with various embodiments.

FIGS. 11A-11B illustrate a side views of a lubrication channel insert, in accordance with various embodiments.

FIGS. 12A-12E illustrate several cross-sectional views of a lubrication channel inserts, in accordance with various embodiments.

FIGS. 13A and 13B illustrate a perspective and side view respectively of a lubrication channel insert, in accordance with various embodiments.

FIGS. 14A and 14B illustrate a perspective and side view respectively of a lubrication channel insert, in accordance with various embodiments.

FIG. 15 illustrates a perspective view of a lubrication channel insert, in accordance with various embodiments.

FIGS. 16A and 16B illustrate a perspective and side view respectively of a lubrication channel insert, in accordance with various embodiments.

FIGS. 17A and 17B illustrate a perspective and side view respectively of a lubrication channel insert, in accordance with various embodiments.

FIG. 18 illustrates a perspective view of a lubrication channel insert, in accordance with various embodiments.

FIG. 19 illustrates a perspective view of cross-section of a lubrication channel insert that includes an over-molded central channel portion, in accordance with various embodiments.

FIG. 20 illustrates a perspective view of cross-section of a lubrication channel insert that includes features on the face for sealing, in accordance with various embodiments.

FIGS. 21 and 22 illustrate a perspective view of cross-section and a top view of a lubrication channel insert that includes a tapered channel with a variable cross-section, in accordance with various embodiments.

FIGS. 23-25 illustrate a perspective view of a cross-section, a top view and a bottom view of a lubrication channel insert that includes a tapered channel and an inline filter, in accordance with various embodiments.

### DETAILED DESCRIPTION OF DISCLOSED EMBODIMENTS

In the following detailed description, reference is made to the accompanying drawings, which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

A continual problem in guide bar manufacture is how to produce a guide bar that provides oil, grease, or other lubricant to the saw chain as it rides in the groove disposed between rails of the guide bar. Typically this is accomplished by providing a transverse oil channel that is in fluid connection with an oil-feed channel running to the bottom of the chain. The oil is typically delivered to the bottom groove of the chain bar. When the bar is connected to the motor housing, the transverse oil channel is mated to an oil supply, for example in fluid connection with an oil reservoir and/or oil pump. During use, oil or other lubricant is passed, either passively or actively, from the reservoir and/or oil pump to the bottom of the groove where it can be taken up by chain links as they pass over an outlet for the oil. Typically, to connect the transverse oil channel to the bottom of the groove, a hole must be drilled through the bottom of the groove to the transverse oil channel. This machining step is difficult and time consuming because the oil feed channel typically needs to be drilled with a small diameter drill bit or other cutter after the groove has been formed. Because the guide bars are typically made of hardened material, special drilling tools or special methods, such as eroding or laser techniques or the like, are necessary for making the channels through the thin groove. In addition, this channel can typically only be made with uniform diameter equal to or less than the width of the channel. These, and other problems, may be solved by the devices and systems of the present disclosure.

In various embodiments, saw chain may be configured to be driven on a guide bar of a chain saw, such as a harvester guide bar. The guide bar may extend from a body of the chain saw, for example clamped or otherwise connected to the body of the chain saw. In various embodiments, the guide bar comprises a body having a first side and a second side, the body extending from the proximal end of the guide bar to the distal end of the guide bar where it terminates with a curved nose portion at the distal end. The guide bar may further include a pair of rails having a groove disposed between the pair of rails, the pair of rails running around the body of the guide bar, for example around the perimeter of the guide bar. The groove disposed between the pair of rails may have a groove bottom. In embodiments, the guide bar has a transverse lubrication channel extending at least part way between the first side of the guide bar and the second side of the guide bar.

Embodiments provide for a lubricant delivery system that includes a saw chain guide bar, such as a harvester bar, and an integrated lubrication channel insert that is insertable, removable and/or exchangeable, into the saw chain guide bar. Oil, grease, or other lubricant can be passed to the chain to lubricate the chain during use though the lubrication channel insert, as disclosed herein. The lubricant enters the groove in the bar via the lubrication channel insert opening into the guide groove in the region of the groove bottom. The lubrication channel insert is coupled to the guide bar and is fed from a transverse channel below the groove bottom. This transverse lubrication channel has at least one entry opening on an outer side of the guide bar. The transverse channel may also be completely within the insert.

In embodiments, the lubrication channel insert seats into a cutout that is formed in the guide bar that approximates the shape of the lubrication channel insert. This cutout extends at least partially, or fully, through the guide bar. The transverse lubrication channel and the cutout may be machined, laser cut, punched or otherwise formed in the guide bar prior to the bar groove formation, which connects, fluidly, the groove to the transverse lubrication hole. In embodiments, the guide bar has an insert cutout extending at least partially between the first side and the second side of the guide bar, wherein the cutout overlaps the groove bottom. In other words, the cutout exposes the bottom of the groove, such that oil, grease, or other lubricant can be passed from the lubrication channel insert to the groove bottom, and hence the chain riding in the groove. Because the cutout overlaps with the groove bottom, the lubrication channel insert, such as described herein, can be seated into the cutout and provide a channel for directing lubricant from the transverse lubrication channel to the groove bottom. In certain embodiments, the transverse lubrication channel and/or the insert cutout extend fully through the guide bar. In certain embodiments, the insert cutout is oriented in the direction of travel of a chain moving in the running direction.

Embodiments herein further provide for a lubrication channel insert for a chain saw bar that directs lubricant to a saw chain, such as a drive link of saw chain mounted to a saw chain guide bar. In embodiments, the lubrication channel insert includes a proximal end, a distal end, and a longitudinal lubrication channel running from the proximal end to the distal end. The longitudinal lubrication channel is configured to couple the transverse lubrication channel to the groove bottom of a guide bar when seated into a guide bar having the appropriate cutout. In embodiments, the lubrication channel insert includes a radiused portion at the proximal end that matches, at least approximately, the radius of the transverse lubrication channel. In certain embodiments, the radiused region forms a complete circle. In certain embodiments, the radiused region does not form a complete circle, but only a portion thereof. Thus, as is depicted in the figures below, the lubrication channel insert does not fill, or insert within, the transverse lubrication channel of a guide bar. In embodiments, the radiused portion of the lubrication channel insert forms a portion of the wall of the transverse lubrication channel.

In embodiments the lubrication channel insert is non-symmetrical, for example the body of the lubrication channel insert has a non-symmetrical profile or a protrusion from the body, such as a tab, for example a location tab that extends from the main body of the lubrication channel insert. In some embodiments, the lubrication channel insert may appear symmetrical from its outside appearance, with the exception of the protruding location tab. In other embodiments, the lubrication channel insert body has a non-symmetrical face, which may be separate from the location tab. In some embodiments, the lubrication channel insert body has a symmetrical face and no tab. In some embodiments, the lubrication channel insert body has a non-symmetrical face and no tab. In some embodiments, the lubrication channel insert body has a symmetrical face and a tab. In some embodiments, the lubrication channel insert body has a non-symmetrical face and a tab. By symmetrical, it is meant that the lubrication channel insert can be spun 180° around its long axis, namely the axis running down the longitudinal lubrication channel, and may appear, at least outwardly, the same, e.g. having a central axis of symmetry. By non-symmetrical, it is meant that the lubrication channel when spun 180° around its long axis, namely the axis running down the longitudinal lubrication channel, would not appear the same, e.g. having no central axis of symmetry. Thus, a non-symmetrical insert has a pre-defined orientation for how it fits within the lubrication insert cutout of the guide bar.

In embodiments, the lubrication channel insert includes a location tab at the distal end that extends into the groove bottom for locating and retaining the lubrication channel insert in the guide bar. Thus, the location tab is typically only found on one side of the lubrication channel insert as it would impinge upon the wall of the cutout on the other side. In embodiments, the lubrication channel insert effectively forms a dam to prevent lubrication from running out the back of the guide bar and provides a well of lubrication for the chain. The location tab may extend into the chain groove to keep the insert in place and increase the size of the lubrication pool.

In some embodiments, the lubrication channel insert has a transverse lubrication channel that completely covers the inlet location and the seal is between the insert and the bar mount. The outer profile may be non-symmetric to maintain the location tab in the correct location.

In some embodiments, the lubrication channel of the lubrication channel insert is tapered, for example tapered from large to small from the proximal end to the distal end. Inclusion of a tapered channel may increase lubricant movement and/or the velocity of the lubricant at the distal end of the lubrication channel insert, thereby increasing the effective penetration of the lubricant. By including a tapered channel, the channel can easily be cleared of debris, for example by removing the lubrication channel insert and tapping or blowing air through the tapered channel. In embodiments, a suitable taper may be about 10-30° divergent from a straight channel. In embodiments, the longitudinal lubrication channel has a varied cross section from the proximal end to the distal end, for example it may change size and/or shape from one end to the other. In embodiments, the lubrication channel tapers from the proximal end to the distal end. In embodiments, the proximal end of the lubrication channel insert includes a chamfer that acts to funnel the lubricant from the transverse lubrication hole into the lubrication channel insert.

In some embodiments, the lubrication channel insert includes a small lip, ring, rib, or gasket that would fit around the opening into which it is inserted, for example to help retain and/or seal the lubrication channel insert into the opening. In some embodiments, the entire insert may be thicker than the guide bar, for example to help enable sealing between the insert and the cutting attachment. In certain embodiments, the lip or gasket is configured to seal the lubrication channel insert in the lubrication insert cutout. In certain embodiments, the lubrication channel insert includes a protrusion on the face of the lubrication channel insert that is configured to seal the transverse lubrication channel to a lubrication delivery system outlet on the body of the chain saw.

The lubrication channel insert can be made of any material, although material that can be easily pressed into the cutout is preferred. In embodiments, the lubrication channel insert is made of plastic part (elastomer, silicone mixture, rubber) or a metal die cast part (aluminum, magnesium).

In some examples, the lubrication channel insert is produced in different versions for different applications and/or lubricant. For example, there can be different versions of the lubrication channel insert for oil and for grease, which, in certain embodiments, may be color coded, differently shaped, and/or marked for the particular use. In addition, the diameter or cross-sectional size of the lubrication channel may be sized to control the speed of movement of the particular lubricant through the channel. As an example, a larger relative diameter or cross-section may be provided for a channel intended for grease (due to its greater viscosity) compared to the smaller relative diameter or cross-section for a channel intended for use with oil. In embodiments, a suitable diameter for a channel intended for grease is about 2-5 times the cross-sectional area used for oil, around the mid-point of the channel, whereas a suitable diameter for a channel intended for oil is roughly equivalent to the chain's driving link thickness around the mid-point of the channel. In embodiments, the longitudinal lubrication channel of a lubrication channel insert is internally dimensioned for oil passage. In embodiments, the longitudinal lubrication channel of a lubrication channel insert is internally dimensioned for grease passage. In embodiments, the longitudinal lubrication channel of a lubrication channel insert is internally dimensioned for use under different environmental conditions, such as internally dimensioned for cold weather or warmer weather. By way of example, users of oil systems will in certain situations, such as in colder weather, dilute the lubricant to reduce the viscosity during the winter, for example with kerosene. This situation, adds cost, effort, and reduces the efficacy of the intended lubricant. By providing a user with interchangeable lubrication channel inserts, such as seasonal and/or lubricant specific lubrication channel inserts, a user may select the correct lubrication channel insert for the season and/or application and be able to avoid this hassle by simply swapping the oil insert. As discussed above, different inserts may be differently shaped, color coded, marked, or otherwise designated.

It is envisioned that the lubrication insert can be composed of one or more pieces to enable manufacturing and installation of the insert, for example, multiple pieces may be used to create the desired geometry. In embodiments, the longitudinal lubrication channel comprises an overmold or insert within the lubrication channel. The overmolded part could be plastic, another elastomer, a metal, or any number of materials to provide variable hardness in the part. The function may be to maintain the geometry of the central passage while the outer portions of the insert provide sealing and/or retention into the guide bar.

Certain embodiments, whether constructed with an overmolded element or not, may contain an in-line element within the longitudinal lubrication channel, such as a filter, basket, or screen to prevent or limit the passage of foreign, or undesired debris or material within the lubrication system. Additionally, the in line element, such as a filter, basket, or screen may prevent backflow ingress of cutting debris into the currently unlubricated side of the bar or to prevent upstream contamination from clogging the narrow outlet of the insert.

In embodiments, the lubrication channel insert comprises a first half and a second half that couple together to form the lubrication channel insert. In embodiments, internal surfaces are substantially parallel to a front surface of the first half and/or the second half and bisect the lubrication channel insert. In embodiments, the longitudinal lubrication channel first half comprises one or more internal protrusions on an internal surface that fits within a groove in an internal surface of the second half. In embodiments, the longitudinal lubrication channel comprises a hinge region coupling the first half to the second half. They also help prevent lubrication from leaking at the joint. While all of the designs can be removed and cleaned, a design in two halves may be easiest to clean in the field.

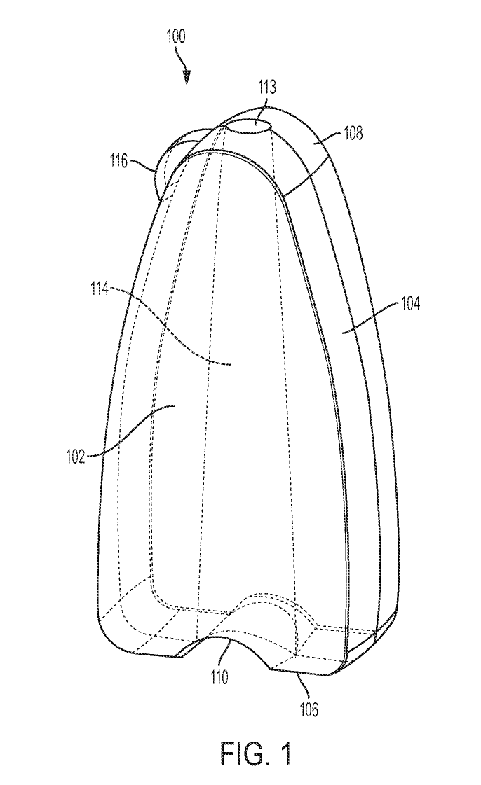

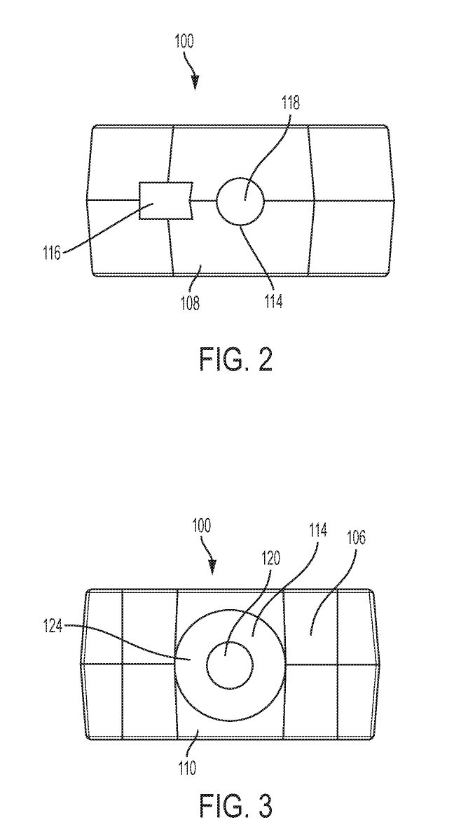

FIGS. 1-3 are various views of a lubrication channel insert 100, in accordance with various embodiments. FIG. 1 is perspective view of the lubrication channel insert 100, while FIG. 2 and FIG. 3 are top and bottom views of the lubrication channel insert 100, respectively. The lubrication channel insert 100 includes a front face 102, sides 105, a proximal end 106, and a distal end 108. The lubrication channel insert 100 also includes a channel, such as a tapered channel 114 running longitudinally from the proximal end 106 to the distal end 108, through which oil, grease, or other lubricant flows. In the embodiment shown, the tapered channel 114 may increase the velocity of the lubricant at the distal end of the lubrication channel insert 100, thereby increasing the effective penetration of the lubricant. In the embodiment shown, the distal end 108 of the lubrication channel insert 100, includes a radiused region 110 that matches, at least approximately, the radius of a lubrication hole of saw chain guide bar, such as a harvester bar. In embodiments, the radiused region 110 does not form a complete circle, but only a portion thereof. Thus, the lubrication channel insert 100 does not fill or insert within the transverse lubrication channel in the guide bar. In the embodiments the lubrication channel insert 100 further includes a location tab 116. In some embodiments, the lubrication channel insert 100 includes a small lip/gasket to fit around the opening into which it is inserted, for example to help retain and/or seal the lubrication channel insert 100 in the opening.

As best shown in FIG. 2, the channel 114 of the lubrication channel insert 100 terminates at the distal end 108 with a hole 118. When in use, the distal end 108 of the lubrication channel insert 100 comes into close proximity with the lower extension of a drive link and oil, or other lubricant, is passed from the hole 118 to the drive link, thereby lubricating the drive link and hence the saw chain and/or guide bar. Also shown in FIG. 2 is the location tab 116, which fits into the lower portion of the groove of a guide bar when properly inserted. The location tab 116 of the lubrication channel insert 100 ensures proper orientation and retains the lubrication channel insert 100 in the guide bar.

As best shown in FIG. 3, the lubrication channel 114 of the lubrication channel insert 100 begins at the proximal end 106 with a hole 120. When in use, lubricant is fed into the channel 114 of the lubrication channel insert 100, for example from a hole that is transverse to the saw chain guide bar and in fluid contact with a lubrication system. FIG. 3 also shows chamfer 124 that acts to funnel the lubricant from the transverse lubrication hole into the lubrication channel insert 100.

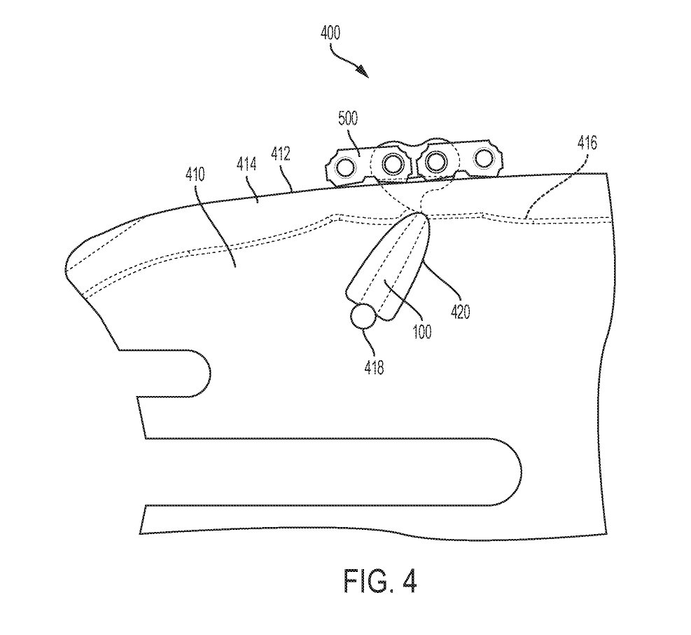

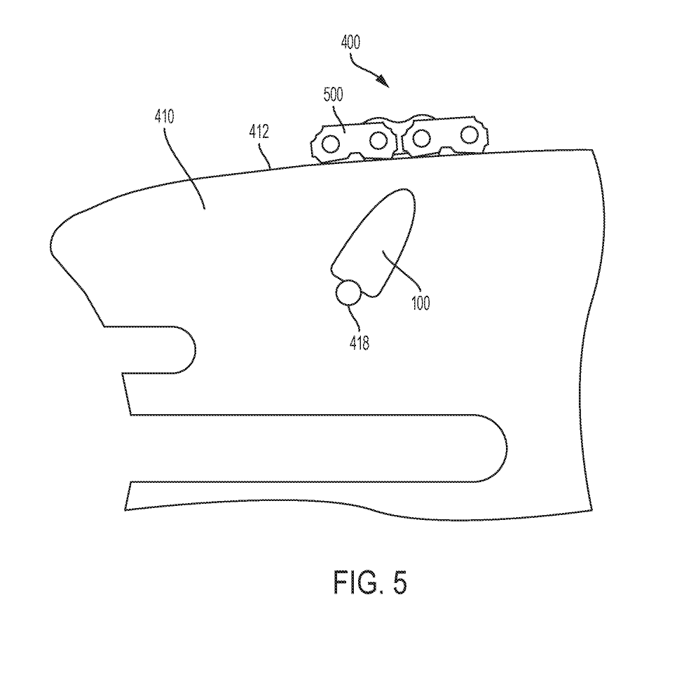

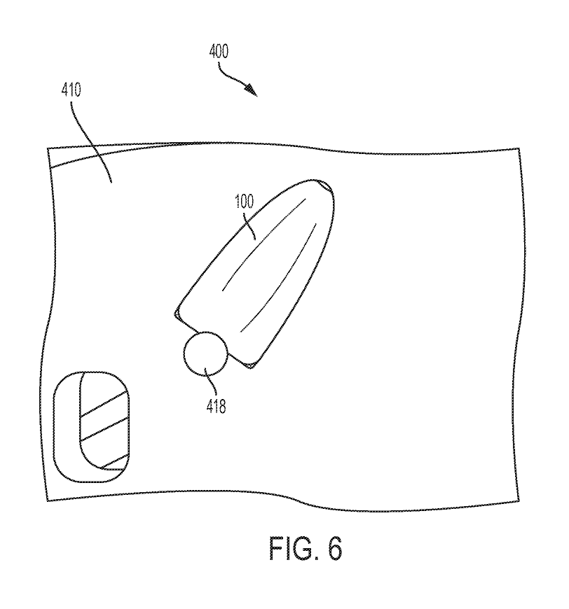

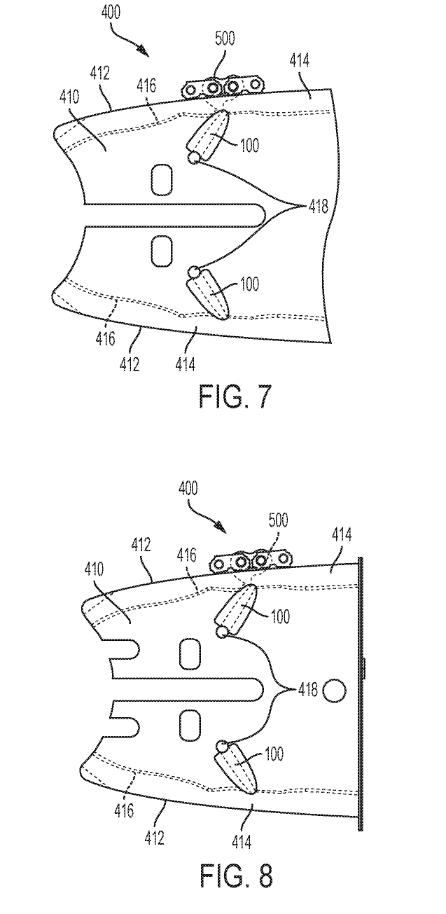

FIGS. 4-8 show various views of a system 400 for providing lubricant to a saw chain 500 and/or a guide bar 410. Guide bar 410 includes rails 412 and a groove 414 disposed between the rails 412. The groove 414 also includes a groove bottom 416, through which the distal end of the lubrication channel insert 100 protrudes. The guide bar 410 also includes a transverse lubrication hole 418. FIGS. 4-8 further show a lubrication channel insert 100 inserted into a cutout 420, such as a machined, or laser cut cutout, in guide bar 410. Lubricant passes through the channel in the lubrication channel insert 100 from the proximal end to the distal end where it is picked-up and dispersed by the saw chain 500.

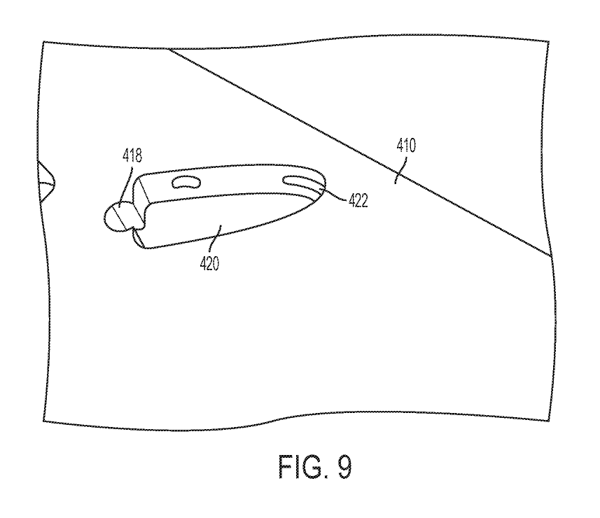

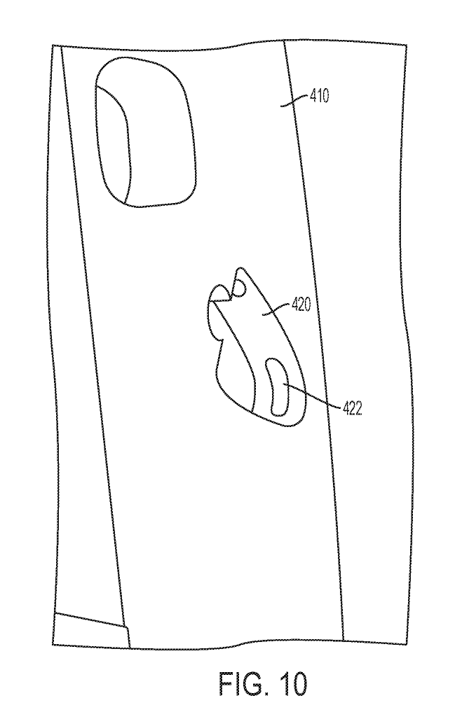

FIGS. 9 and 10 show views of a guide bar 410 with a cutout 420 for receiving a lubrication channel insert (not shown in these views). The cutout 420 includes a transverse lubrication hole 418. Also shown in these views is a slot 422 which passes from the cutout 420 to the groove (element 414 in FIG. 4). This slot is formed from having the cutout 420 cross over into the groove. The slot serves the dual function of providing an orifice for which the lubricant can pass from the lubrication channel insert to the groove, and it provides a location for a location tab (element 116 in FIG. 1) to seat into and thereby locate the insert in the groove and/or cutout 420.

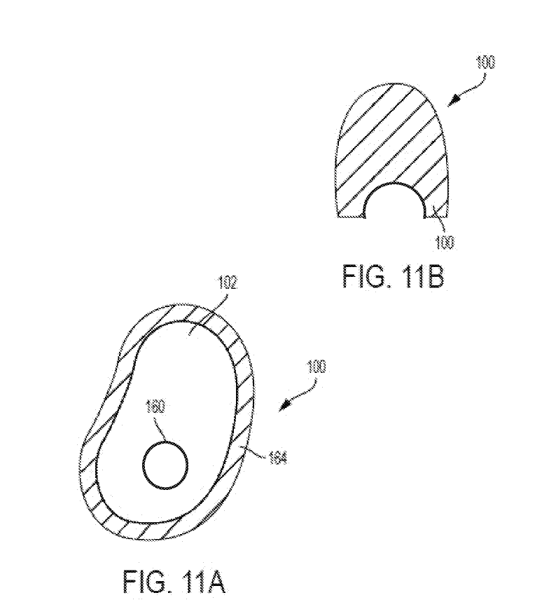

FIGS. 11A-11B illustrate side views of lubrication channel inserts depicting features for helping to secure and or seal the lubrication channel insert in a guide bar and/or to the oil feed system of a chainsaw head, in accordance with various embodiments. FIG. 11A shows an embodiment of a lubrication channel insert 100 having a transverse lubrication channel 160. Disposed around the front face 102 is a lip 164 that extends laterally from the front face 102 of the lubrication channel insert 100. This extended lip 164 may help to seal the lubrication channel insert 100 in an opening of chainsaw bar. Although not shown, it is envisioned that the same feature could extend from the back face of the lubrication channel insert 100. FIG. 11B shows an embodiment in which the body of the lubrication channel insert 100 is made oversized in thickness relative to the thickness or width of a chainsaw bar into which it is inserted. As the bar is clamped or otherwise mounted, the lubrication channel insert 100 is compressed creating a tight seal.

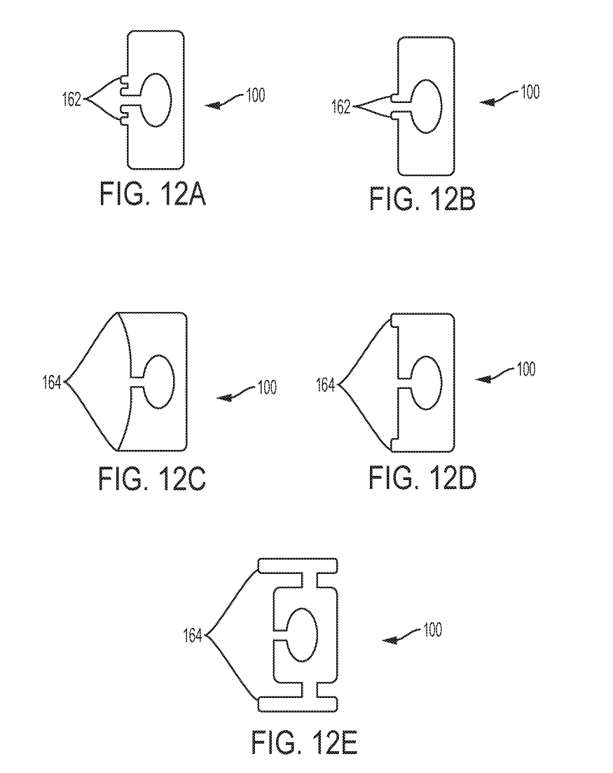

FIGS. 12A-12E illustrate several cross-sectional views of lubrication channel inserts, in accordance with various embodiments. The lubrication channel inserts 100 include various central lips 162 and edge lips 164 that help to seal the lubrication channel inserts 100 into a guide bar and/or seal the lubrication channel inserts 100 to a chain oiling system of a chain saw. These features can be used in any combination.

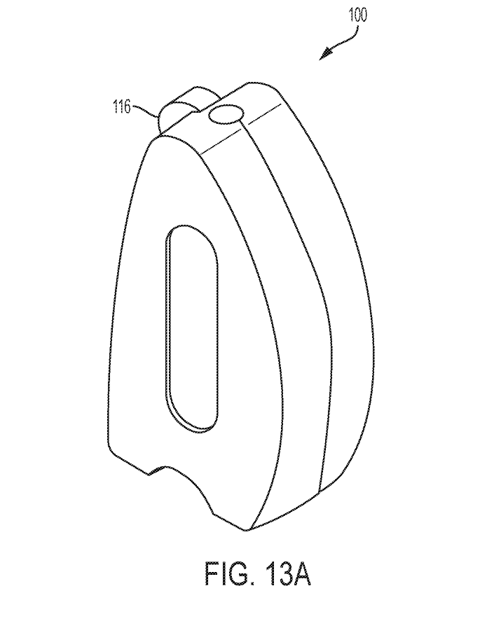

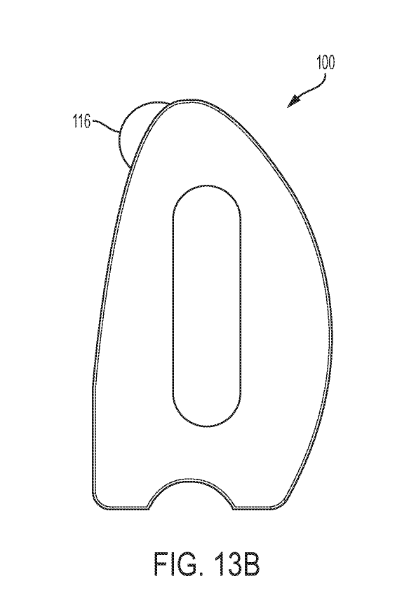

FIGS. 13A and 13B illustrate an embodiment of a lubrication channel insert that has a non-symmetric profile. The non-symmetric profile of lubrication channel insert 100 makes it difficult to install the insert incorrectly. This asymmetry keeps the location tab 116 in the correct location. In other embodiments, a location tab may not be provided.

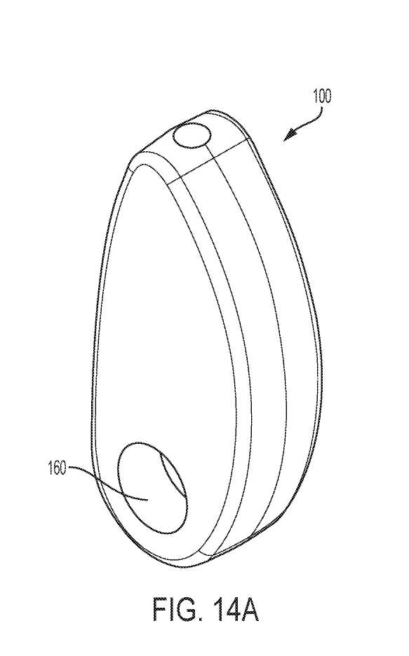

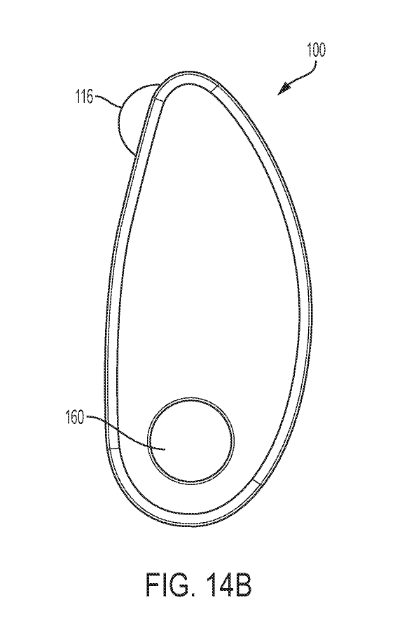

FIGS. 14A and 14B illustrate an embodiment of a lubrication channel insert that has a non-symmetric profile. In this embodiment, the lubrication channel insert 100 has a transverse lubrication channel 160 that completely covers the inlet location and the seal is between the insert and the bar mount. The outer profile is still asymmetric to maintain the location tab 116 in the correct location.

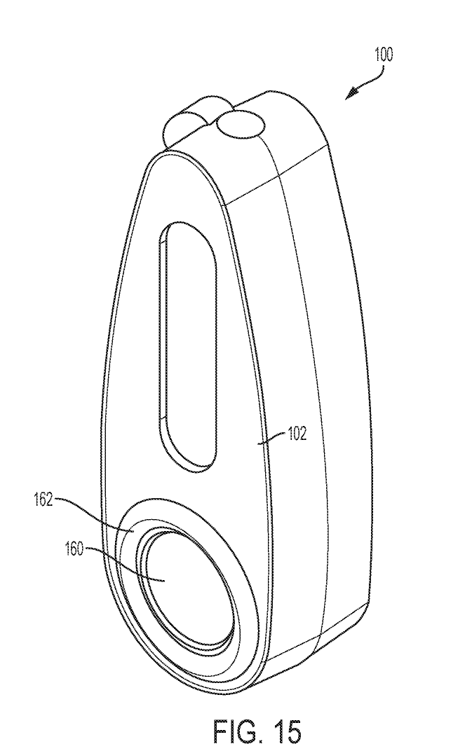

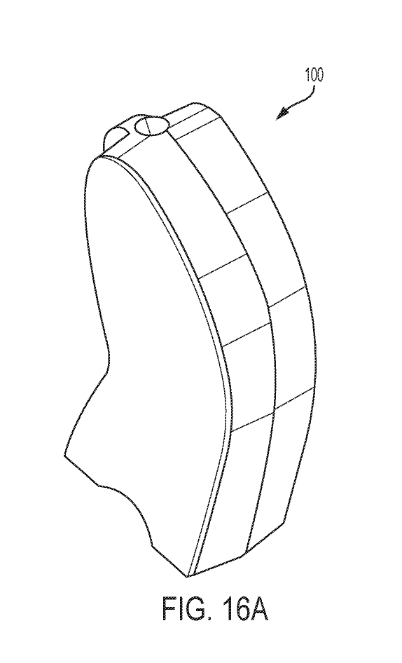

FIG. 15 shows an embodiment of a lubrication channel insert 100 having a transverse lubrication channel 160. Disposed around the oil feed hole 160 is a lip 162 that extends outward from the a front face 102 of the lubrication channel insert 100. This extended lip 162 may help to seal the transverse lubrication channel 160 to the oil feed system of a chainsaw. Although not shown, it is envisioned that the same feature could extend from the back face of the lubrication channel insert 100.

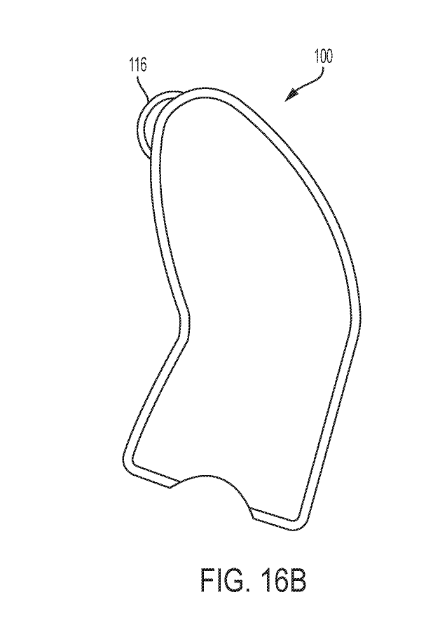

FIGS. 16A and 16B show an embodiment of a lubrication channel insert 100 having an asymmetric outer profile. The channel in this part may also be curved, as opposed to straight. The outer profile is still asymmetric to maintain the location tab 116 in the correct location.

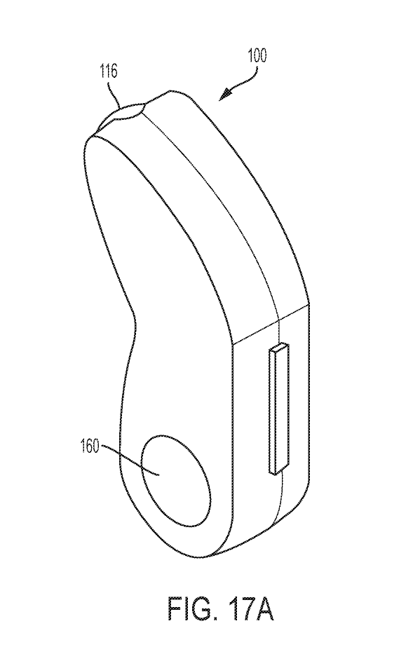

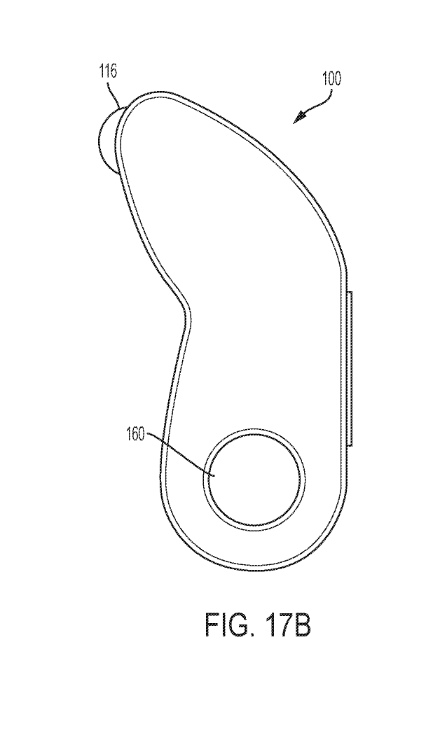

FIGS. 17A and 17B show an embodiment of a lubrication channel insert 100 having a transverse lubrication channel 160. The outer profile is asymmetric to maintain the lubrication channel insert 100 in the correct location.

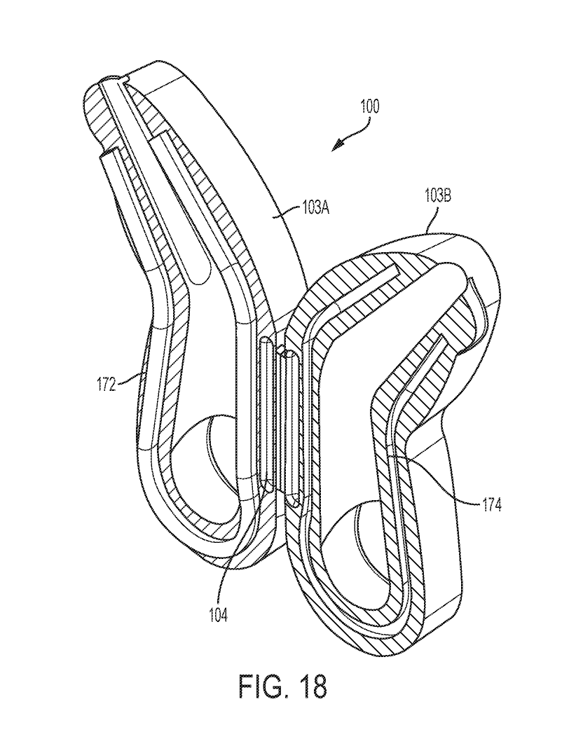

FIG. 18 shows an embodiment of a lubrication channel insert 100, which could be made in two halves 103A and 103B connected with or without a hinge 104. The protrusion 172 and grooves 174 on the interior hold the two halves 103A, 103B together during shipping and installation. They also help seal in lubrication from leaking at the joint. While all of the designs can be removed and cleaned, a design in two halves may be easiest to clean in the field.

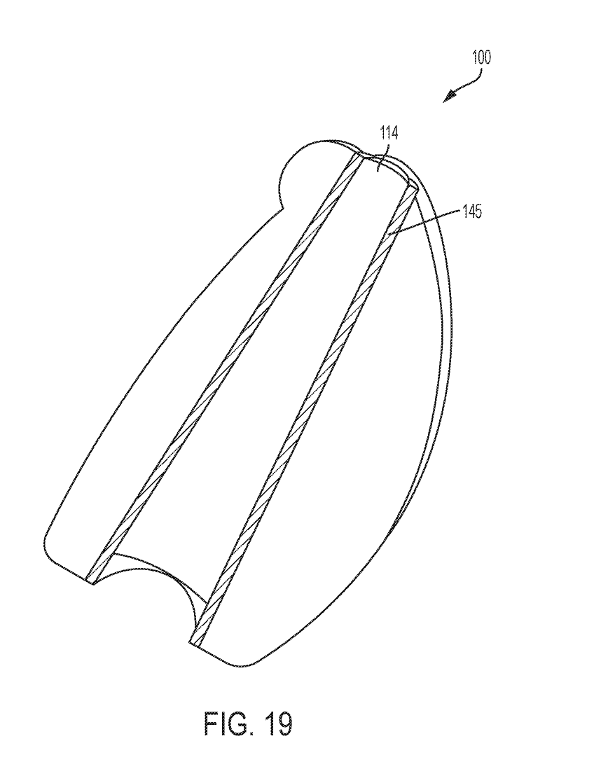

FIG. 19 shows an embodiment of a lubrication channel insert 100, with channel 114 running longitudinally from the proximal end to the distal end, through which oil, grease, or other lubricant flows. The channel 114 includes a channel insert 145 that is held within the channel 114. The channel insert 145 may be overmolded by the lubrication channel insert 100 and can be formed of plastic, another elastomer, a metal, or any number of materials to provide variable hardness in the part. In embodiments, the channel insert 145 maintains the geometry of the central passage while the outer portions of the insert provided sealing and/or retention in the guide bar.

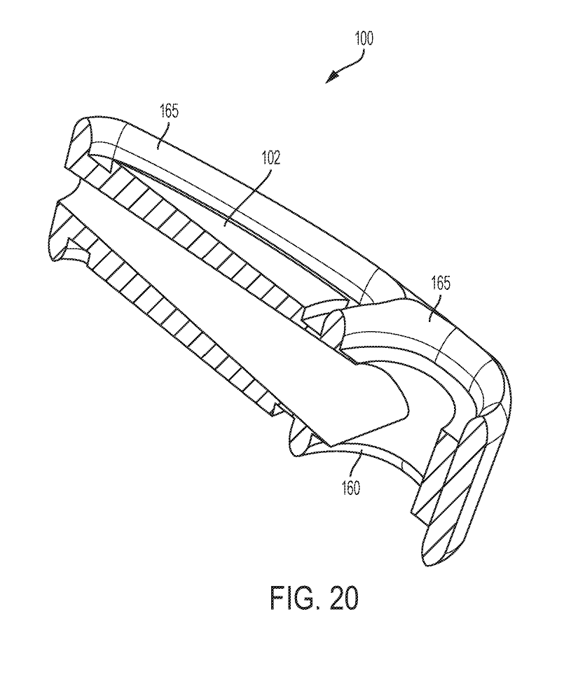

FIG. 20 shows an embodiment of a lubrication channel insert 100 with sealing features on the face of the lubrication channel insert 100. The embodiment shown includes an extension or protrusion 165 from the transverse lubrication channel 160 and an extension or protrusion 167 from the front face 102 of the lubrication channel insert 100.

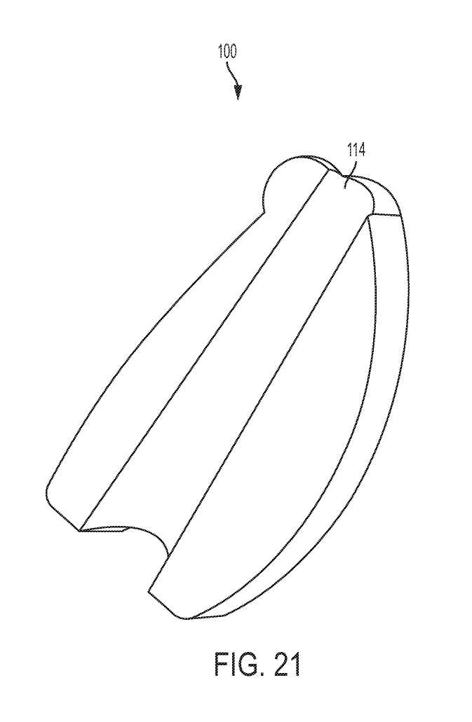

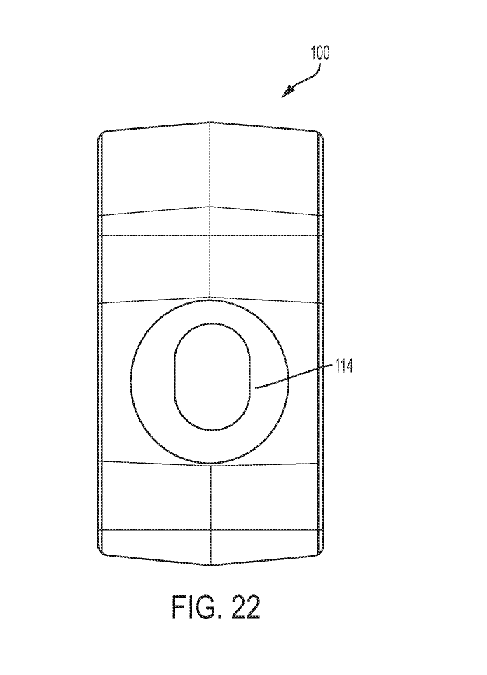

FIGS. 21 and 22 show an embodiment of a lubrication channel insert 100, and a channel 114 with varying cross section. The channel 114 starts round at the inlet, but transitions to oval at the outlet. This provides the function of adapting the insert to various lubricants or to aid in cleaning the insert while still maintaining sealing at both ends of the insert.

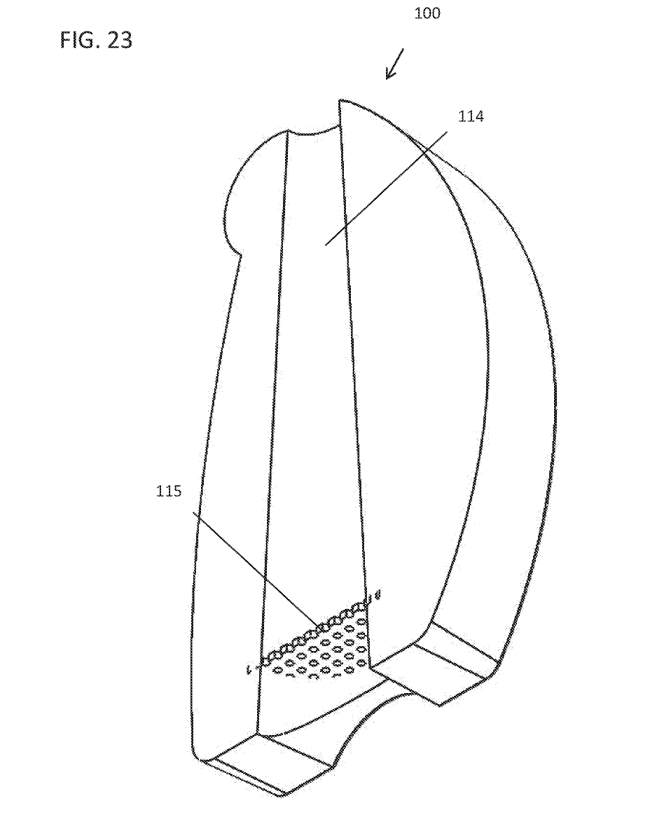

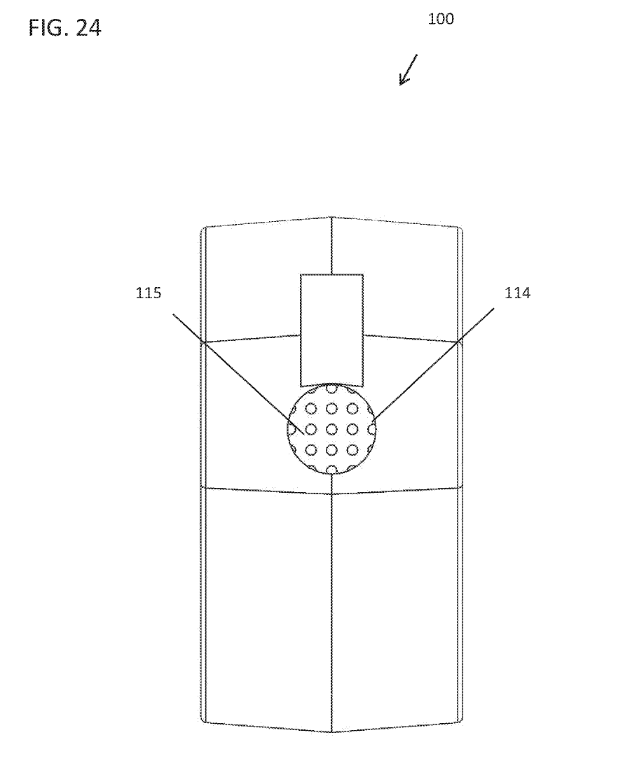

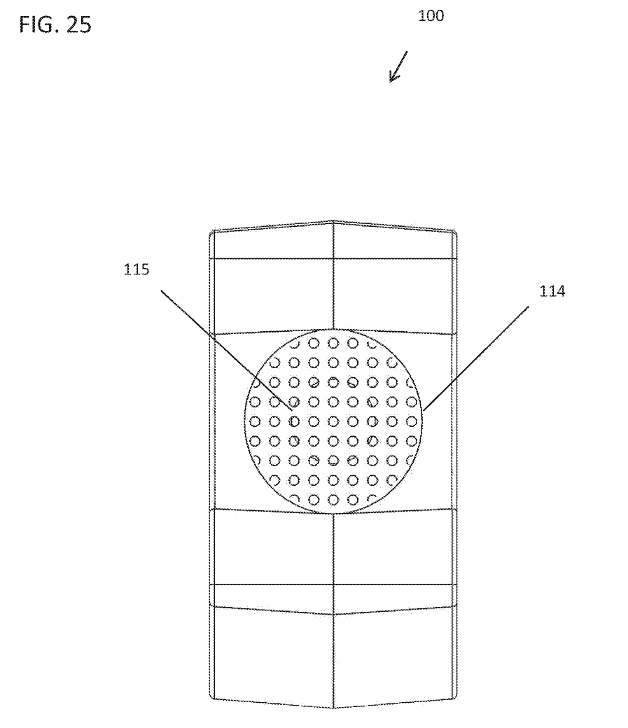

FIGS. 23-25 show an embodiment of a lubrication channel insert 100, and a channel 114 having an inline filter 115. The channel 114 starts round at the inlet, but transitions to oval at the outlet. Filter 115 provides the function of adapting the insert to filter out larger or undesirable material from the lubricant stream.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. An lubrication system for a saw chain, comprising:
a guide bar configured to couple at a proximal end to a body of a chain saw, the guide bar comprising:
a body having a first side and a second side and extending from the proximal end of the body to the distal end of the body and terminating with a curved nose portion;
a pair of rails around the perimeter of the body and having a groove disposed between the pair of rails;
a groove bottom;
a transverse lubrication channel extending at least partially between the first side and the second side; and
a lubrication insert cutout extending at least partially between the first side and the second side, wherein the cutout overlaps the groove bottom; and
a lubrication channel insert with a non-symmetrical body with respect to rotation about a central axis running down the longitudinal lubrication channel that seats into the lubrication insert cutout, the lubrication channel insert comprising:
a proximal end, a distal end, a front face, and a longitudinal lubrication channel running from the proximal end to the distal end and coupling the transverse lubrication channel to the groove bottom.

2. The lubrication system of claim 1, wherein the non-symmetrical body comprises a location tab at the distal end that extends into the groove bottom for locating and retaining the lubrication channel insert in the guide bar.

3. The lubrication system of claim 1, wherein the front face has a non-symmetric profile.

4. The lubrication system of claim 1, wherein the lubrication channel insert comprises a radiused portion at the proximal end that matches the radius of the transverse lubrication channel.

5. The lubrication system of claim 4, wherein the radiused portion comprises a full circle.

6. The lubrication system of claim 4, wherein the radiused portion comprises only a portion of a full circle.

7. The lubrication system of claim 1, wherein the transverse lubrication channel and the lubrication channel insert extend fully through a thickness of the guide bar.

8. The lubrication system of claim 1, wherein the longitudinal lubrication channel is angled toward a running direction of a chain mounted to the guide bar.

9. The lubrication system of claim 1, wherein the longitudinal lubrication channel of lubrication channel insert is internally dimensioned for oil passage or grease passage.

10. The lubrication system of claim 1, wherein the longitudinal lubrication channel has a varied cross section from the proximal end to the distal end.

11. The lubrication system of claim 9, wherein the longitudinal lubrication channel tapers from the proximal end to the distal end.

12. The lubrication system of claim 1, wherein the longitudinal lubrication channel comprises an overmold or insert within the lubrication channel.

13. The lubrication system of claim 1, wherein the lubrication channel insert comprises a first half and a second half that couple together to form the lubrication channel insert.

14. The lubrication system of claim 1, wherein the lubrication channel insert comprises a lip or gasket extending circumferentially around the outer profile of the lubrication channel insert that is configured to seal the lubrication channel insert in the lubrication insert cutout.

15. The lubrication system of claim 1, wherein the lubrication channel insert comprises a protrusion on the front face of the lubrication channel insert that is configured to seal the transverse lubrication channel insert to a lubrication delivery system outlet on the body of the chain saw.

16. The lubrication system of claim 1, wherein the lubrication channel insert comprises a lip or gasket on the front face of the lubrication channel insert that is configured to seal the lubrication channel insert in the lubrication insert cutout.

17. A non-symmetrical lubrication channel insert that seats into a lubrication insert cutout of a chain saw guide bar, the lubrication channel insert comprising:
a non-symmetrical body with respect to rotation about a central axis running down the longitudinal lubrication having a proximal end, a distal end, a front face, and a longitudinal lubrication channel running from the proximal end to the distal end and coupling the transverse lubrication channel to a groove bottom of the guide bar.

18. The lubrication channel insert of claim 17, wherein the non-symmetrical body comprises a location tab at the distal end that extends into the groove bottom for locating and retaining the lubrication channel insert in the guide bar.

19. The lubrication channel insert of claim 17, wherein the front face has a non-symmetric profile.

20. The lubrication channel insert of claim 17, wherein the lubrication channel insert comprises a radiused portion at the proximal end that matches a radius of the transverse lubrication channel.

21. The lubrication channel insert of claim 20, wherein the radiused portion comprises a full circle.

22. The lubrication channel insert of claim 20, wherein the radiused portion comprises only a portion of a full circle.

23. The lubrication channel insert of claim 17, wherein the longitudinal lubrication channel of the lubrication channel insert is internally dimensioned for oil passage or grease passage.

24. The lubrication channel insert of claim 17, wherein the longitudinal lubrication channel has a varied cross section from the proximal end to the distal end.

25. The lubrication channel insert of claim 24, wherein the longitudinal lubrication channel tapers from the proximal end to the distal end.

26. The lubrication channel insert of claim 17, wherein the longitudinal lubrication channel comprises an overmold or insert within the lubrication channel.

27. The lubrication channel insert of claim 17, wherein the lubrication channel insert comprises a first half and a second half that couple together to form the lubrication channel insert.

28. The lubrication channel insert of claim 17, wherein the lubrication channel insert comprises a lip or gasket extending circumferentially around the outer profile of the lubrication channel insert that is configured to seal the lubrication channel insert in the lubrication insert cutout.

29. The lubrication channel insert of claim 17, wherein the lubrication channel insert comprises a protrusion on the front face of the lubrication channel insert that is configured to seal the transverse lubrication channel insert to a lubrication delivery system outlet on the body of the chain saw.

30. The lubrication channel insert of claim 17, wherein the lubrication channel insert comprises a lip or gasket on the front face of the lubrication channel insert that is configured to seal the lubrication channel insert to the lubrication insert cutout.

31. A lubrication channel insert that seats into a lubrication insert cutout of a chain saw guide bar, the lubrication channel insert comprising:
a proximal end, a distal end, a front face, and a longitudinal lubrication channel that tapers from the proximal end to the distal end and coupling the transverse lubrication channel to a groove bottom of the guide bar.

32. The lubrication channel insert of claim 31, wherein the lubrication channel insert comprises a radiused portion at the proximal end that matches a radius of the transverse lubrication channel.

33. The lubrication channel insert of claim 31, wherein the longitudinal lubrication channel of the lubrication channel insert is internally dimensioned for oil passage or grease passage.

34. The lubrication channel insert of claim 31, wherein the longitudinal lubrication channel comprises an overmold or insert within the lubrication channel.
